(19) United States
(12) Patent Application Publication
(10) Pub. No.: US 2002/0117125 A1
(43) Pub. Date: Aug. 29, 2002

(54) Fuel system using photovoltaic panel

(75) Inventors: Harold A. McMaster, Perrysburg, OH (US); Robert G. McMaster, Elmore, OH (US)

Correspondence Address: James A. Kushman, Brooks & Kushman P.C., 1000 Town Center, 22nd Floor, Southfield, MI, 48075-1351, US

(73) Assignee: McMaster Fuel, Ltd., Perrysburg, OH (US)

(21) Appl. No.: 09/849,072

(22) Filed: May 4, 2001

Related U.S. Application Data
(62) Division of application No. 09/795,163, filed on Feb. 27, 2001.

(51) Int. Cl. F02B 43/08

(52) U.S. Cl. 123/3

(57) ABSTRACT

A closed loop fuel system (10) for an internal combustion engine (12) includes a water tank (14) in which water is electrolyzed to provide hydrogen and oxygen gases that are pressurized for storage in respective tanks (26, 30) for flow to the engine and combustion prior to exhaust flow to a condenser (40) and recycling back into the water tank. The fuel system (10) includes an auxiliary water supply (68) that lowers the burn temperature of the engine and provides additional steam under pressure for operation of the engine as well as providing cooling of the exhaust steam condensed by the condenser (40). A photovoltaic panel (52) can be used to electrolyze the water and provide the hydrogen and oxygen gases.

### BACKGROUND OF THE INVENTION

1. Field of the Invention

This invention relates to a fuel system for providing hydrogen and oxygen to an internal combustion engine.

2. Background Art

While internal combustion engines have previously utilized hydrogen and oxygen gases as a fuel, such engines and fuel systems therefor have not previously found widespread commercial usage.

### SUMMARY OF THE INVENTION

An object of the present invention is to provide an improved fuel system for an internal combustion engine so as to utilize hydrogen and oxygen gases to power the engine.

In carrying out the above object, the fuel system of the invention is of a closed loop operation and includes a water tank for holding water that is electrolyzed to provide hydrogen gas and oxygen gas. A pump pressurizes the hydrogen gas and the oxygen gas, and first and second tanks of the fuel system respectively store the pressurized hydrogen and oxygen gases received from the pump. First and second conduits of the fuel system respectively feed the pressurized hydrogen and oxygen gases to the internal combustion engine for combustion that provides exhaust steam. A condenser of the fuel system condenses the exhaust steam for flow back into the water tank for recycling.

In the preferred construction, the water tank includes a cathode and an anode for connection to a source of electrical power to electrolyze the water and provide the hydrogen and oxygen gases. The water tank also preferably includes a pair of electrode covers respectively over the cathode and the anode to respectively capture the hydrogen and oxygen gases for flow to the pump.

In accordance with the invention, it is also possible for a photovoltaic panel to supply electrical power to electrolyze the water within the water tank to provide the hydrogen and oxygen gases.

The first and second tanks of the fuel system for respectively storing the pressurized hydrogen and oxygen each include detachable couplings that permit detachment of empty tanks for replacement with filled tanks as necessary.

A pair of control valves of the fuel system control the flow of pressurized hydrogen and oxygen gases through the first and second conduits for combustion within the associated internal combustion engine.

The fuel system also includes an auxiliary water supply that supplies water from the water tank to the internal combustion engine to lower the burn temperature and provide additional steam under pressure for operation of the engine as well as providing cooling of the exhaust steam that is condensed by the condenser.

### BRIEF DESCRIPTION OF THE DRAWINGS

FIG. 1 is a somewhat schematic view of a closed loop fuel system constructed in accordance with the invention for use with an internal combustion engine.

FIG. 2 is a view that illustrates the manner in which the fuel system can utilize a photovoltaic panel to electrolyze water and provide hydrogen and oxygen gases.

### DETAILED DESCRIPTION OF THE PREFERRED EMBODIMENTS

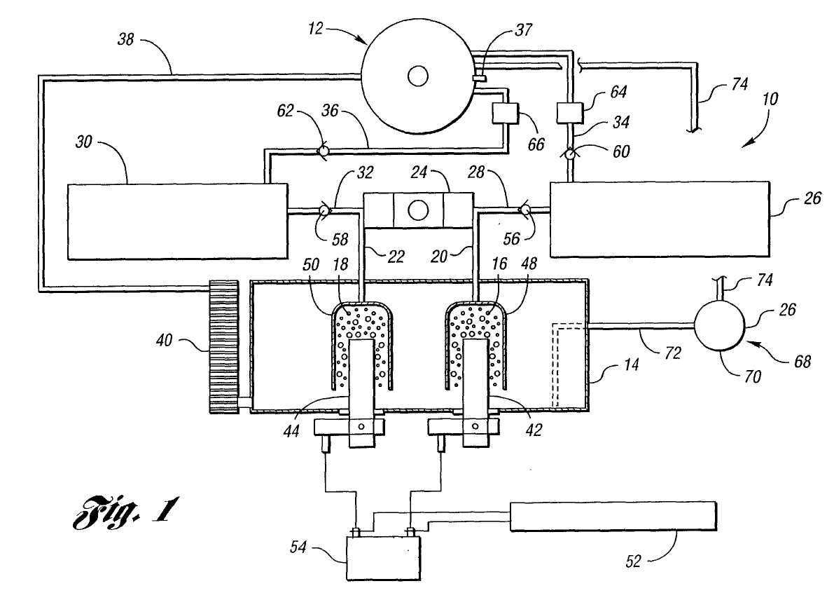

With reference to FIG. 1, a closed loop fuel system generally indicated by 10 is constructed in accordance with the present invention as is hereinafter more fully described and is utilized to supply fuel to an associated internal combustion engine 12. The fuel system 10 has particular utility when utilized to supply fuel to a wobble engine of the type disclosed by U.S. patent application Ser. No. 09/690,638, filed Oct. 17, 2000 by Harold A. McMaster and Robert G. McMaster and by U.S. patent application Ser. No. (Docket No. MHA 0104 PUS) filed on Feb. 5, 2001, by Harold A. McMaster and Robert G. McMaster, the entire disclosures of which are hereby incorporated by reference.

As illustrated in FIG. 1, the fuel system 10 includes a water tank 14 for holding water. An electric voltage electrolyzes the water to provide hydrogen gas 16 and oxygen gas 18. The hydrogen and oxygen gases 16 and 18 are respectively fed through conduits 20 and 22 to a pump 24 whose pumping pressurizes the gases. The pump 24 can be a single pump that operates with suitable valving to pressurize the gases or can be a dual pump that reduces the valving required. The pressurized hydrogen gas is fed to a first tank 26 through a conduit 28 and the pressurized oxygen gas is fed to a second tank 30 through a conduit 32. The gas is pressurized to a great extent, on the order of 5,000 psi. The pump 24 can be of a conventional rotary or piston type and can also be of the more recently developed type where a voltage is applied on opposite sides of a membrane to provide an electromotive force that pressurizes the gas.

Conduits 32 and 34 of the fuel system respectively feed the pressurized hydrogen and oxygen gases to the associated internal combustion engine 12 for ignition by a schematically indicated spark plug 37 in order to operate the engine. After the combustion, the hydrogen and oxygen are combined as exhaust steam that is fed through an exhaust conduit 38 to a condenser 40. From the condenser 40, the condensed water is fed back into the water tank 14 for recycling.

The fuel system 10 operating as a closed system thus does not have any external exhaust as with most other engines and fuel systems.

With continuing reference to FIG. 1, the water tank 14 includes a cathode 42 and an anode 44 across which an electrical voltage is supplied from a source 46 to provide the electrolysis of the water. The water tank includes a pair of electrode covers 48 and 50 that respectively cover the cathode 42 and the anode 44 to respectively capture the hydrogen and oxygen gases for flow through the conduits 20 and 22 to the pump 24.

The closed loop fuel system 10 described above has particular utility for use with vehicles and can utilize a conventional household electrical outlet through a suitable rectifier for electrolyzing the water to provide the hydrogen and oxygen gases that operate the engine. Furthermore, as illustrated in FIG. 2, it is also possible to utilize a photovoltaic panel 52 that supplies electrical power to electrolyze the water either directly or through the use of a storage battery 54.

It is also possible to have additional hydrogen and oxygen tanks 26 and 30 that can replace empty tanks on the vehicle when there is insufficient time to perform the water electrolysis before use of the vehicle is again required. In that connection, the conduits 28 and 32 have detachable couplings 56 and 58, and the conduits 34 and 36 have detachable couplings 60 and 62. Furthermore, the conduits 34 and 36 that respectively supply the hydrogen and oxygen gases to the engine 12 have respective control valves 64 and 66 that can be controlled to control the amount and timing of the fuel flow. It is also possible for the vehicle to carry a bank of batteries to permit the electrolysis to be performed as the vehicle is being used.

The fuel system 10 illustrated in FIG. 1 also includes a auxiliary water supply 68 that includes a pump 70 for receiving water from the tank 14 through a conduit 72 and for pumping the water through another conduit 74 to the engine. This additional water lowers the burn temperature and also provides additional steam under pressure for operation of the engine as well as providing cooling of the exhaust steam that flows through the exhaust conduit 38 to the condenser 40 for the recycling back into the water tank 14.

While the best mode for carrying out the invention has been described in detail, those familiar with the art to which this invention relates will recognize various alternative embodiments for practicing the invention as defined by the following claims.

What is claimed is:

1. A closed loop fuel system for an internal combustion engine, comprising:
a water tank for holding water that is electrolyzed to provide hydrogen gas and oxygen gas;
a pump for pressurizing the hydrogen gas and the oxygen gas;
first and second tanks for respectively storing the pressurized hydrogen and oxygen gases received from the pump;
first and second conduits for respectively feeding the pressurized hydrogen and oxygen gases to the internal combustion engine for combustion that provides exhaust steam; and
a condenser that receives and condenses the exhaust steam for flow back into the water tank for recycling.

2. A closed loop fuel system for an internal combustion engine as in claim 1 wherein the water tank includes a cathode and an anode for connection to a source of electrical power to electrolyze the water and provide the hydrogen and oxygen gases.

3. A closed loop fuel system for an internal combustion engine as in claim 2 wherein the water tank includes a pair of electrode covers respectively over the cathode and the anode to respectively capture the hydrogen and oxygen gases for flow to the pump.

4. A closed loop fuel system for an internal combustion engine as in claim 2 further including a photovoltaic panel for connection to the cathode and the anode to electrolyze the water within the water tank to provide the hydrogen and oxygen gases.

5. A closed loop fuel system for an internal combustion engine as in claim 1 wherein the first and second tanks that store the pressurized hydrogen and oxygen gases each include detachable couplings that permit detachment for replacement as necessary.

6. A closed loop fuel system for an internal combustion engine as in claim 1 further including a pair of control valves that control the flow of pressurized hydrogen and oxygen gases through the first and second conduits for combustion within the associated internal combustion engine.

7. A closed loop fuel system for an internal combustion engine as in claim 1 further including an auxiliary water supply that supplies water from the water tank to the internal combustion engine to lower the burn temperature and provide additional steam under pressure for operation of the engine as well as providing cooling of the exhaust steam that is condensed by the condenser.

8. A closed loop fuel system for an internal combustion engine, comprising:
a water tank for holding water, and the water tank including a cathode and an anode for connection to a source of electrical power to electrolyze the water and provide hydrogen gas and oxygen gas;
a pump for pressurizing the hydrogen gas and the oxygen gas;
first and second tanks for respectively storing the pressurized hydrogen and oxygen gases received from the pump;
first and second conduits for respectively feeding the pressurized hydrogen and oxygen gases to the internal combustion engine for combustion that provides exhaust steam;
a condenser that receives and condenses the exhaust steam for flow back into the water tank for recycling; and
an auxiliary water supply that supplies water from the water tank to the internal combustion engine to lower the burn temperature and provide additional steam under pressure for operation of the engine as well as providing cooling of the exhaust steam that is condensed by the condenser.

9. A closed loop fuel system for an internal combustion engine, comprising:
a water tank for holding water, the water tank including a cathode and an anode for connection to a source of electrical power to electrolyze the water and provide hydrogen gas and oxygen gas, and a pair of electrode covers respectively over the cathode and the anode to respectively capture the hydrogen and oxygen gases;
a pump for pressurizing the hydrogen gas and the oxygen gas received from the electrode covers;
first and second tanks for respectively storing the pressurized hydrogen and oxygen gases received from the pump;
first and second conduits for respectively feeding the pressurized hydrogen and oxygen gases to the internal combustion engine for combustion that provides exhaust steam;
a condenser that receives and condenses the exhaust steam for flow back into the water tank for recycling; and
an auxiliary water supply that supplies water from the water tank to the internal combustion engine to lower the burn temperature and provide additional steam under pressure for operation of the engine as well as providing cooling of the exhaust steam that is condensed by the condenser.

10. A closed loop fuel system for an internal combustion engine, comprising:
a water tank for holding water, and the water tank including a cathode and an anode;
a photovoltaic panel for connection to the cathode and the anode of the water tank to electrolyze the water and provide hydrogen gas and oxygen gas;
a pump for pressurizing the hydrogen gas and the oxygen gas;
first and second tanks for respectively storing the pressurized hydrogen and oxygen gases received from the pump;
first and second conduits for respectively feeding the pressurized hydrogen and oxygen gases to the internal combustion engine for combustion that provides exhaust steam;
a condenser that receives and condenses the exhaust steam for flow back into the water tank for recycling; and
an auxiliary water supply that supplies water from the water tank to the internal combustion engine to lower the burn temperature and provide additional steam under pressure for operation of the engine as well as providing cooling of the exhaust steam that is condensed by the condenser.
